(19) United States
(12) Patent Application Publication
(10) Pub. No.: US 2013/0288093 A1
(43) Pub. Date: Oct. 31, 2013

(54) NONAQUEOUS ELECTROLYTE SECONDARY BATTERY

(71) Applicants: Yasushi Nakagiri, Tokushima (JP); Takaharu Morikawa, Osaka (JP)

(72) Inventors: Yasushi Nakagiri, Tokushima (JP); Takaharu Morikawa, Osaka (JP)

(73) Assignee: PANASONIC CORPORATION, Osaka (JP)

(21) Appl. No.: 13/979,367

(22) PCT Filed: Nov. 18, 2011
(86) PCT No.: PCT/JP2011/006437

§ 371 Date: Jul. 11, 2013

(30) Foreign Application Priority Data
Feb. 28, 2011 (JP) 2011-041354

(51) Int. Cl. H01M 10/04

(52) U.S. Cl. CPC H01M 10/0431
USPC 429/94

(57) ABSTRACT

Provided is a non-aqueous electrolyte secondary battery including: a plurality of electrode groups each formed by winding a positive electrode, a negative electrode, and a separator into a flat shape; a non-aqueous electrolyte; and a prismatic case accommodating the electrode groups and the non-aqueous electrolyte. The case has a rectangular cross-sectional shape. The electrode groups are accommodated in the case such that lateral directions of the cross-sectional shapes of the electrode groups are each perpendicular to the lateral direction of the cross-sectional shape of the case, and the axis directions of the electrode groups are each parallel with the height direction of the case.

### TECHNICAL FIELD

The present invention relates to non-aqueous electrolyte secondary batteries, and specifically relates to an accommodating structure for accommodating a plurality of electrode groups in one prismatic battery case.

### BACKGROUND ART

In recent years, electronic devices are rapidly becoming more portable and cordless. For use as a power source for driving such devices, there is an increasing demand for small-size and light-weight secondary batteries with high energy density. Moreover, characteristics such as high output characteristics, durability over a long period of time, and safety are required not only for secondary batteries for small-size devices, but also for large-size secondary batteries for use in power storage apparatus and electric vehicles. Among secondary batteries, non-aqueous electrolyte secondary batteries with high voltage and high energy density are being developed actively.

Non-aqueous electrolyte secondary batteries represented by lithium ion secondary batteries have a configuration in which, for example, an electrode group is accommodated together with a non-aqueous electrolyte in a cylindrical battery case. The electrode group is formed by winding positive and negative electrodes into a cylindrical shape, with a separator interposed between the positive and negative electrodes. The positive and negative electrodes each have a sheet-like current collector and a material mixture layer formed thereon. One proposal suggests forming a battery into a shape that matches the shape of the battery-mounting space in a device. Specifically, a non-aqueous electrolyte secondary battery including a prismatic battery case (hereinafter referred to as a “prismatic battery”) is also being developed actively so that the dead space left when the battery is mounted on a device can be reduced. A prismatic battery is configured by accommodating a flat wound electrode group in a prismatic battery case.

In such a prismatic battery, it may happen that the thickness of the electrode group is increased as a result of repetitive charge and discharge, causing the battery to swell. If this happens, the swollen battery may interfere with other members in the device, or the device itself may have a swollen appearance. Moreover, if the battery swells, the capacity may be lowered due to the swelling.

The reason why a prismatic battery is easy to swell due to repetitive charge and discharge is in that the electrode group has a flat shape, and therefore, the tightening pressure by winding is small and non-uniform. In addition, the battery case has a flat shape, and therefore, the resistance to pressure is low when the pressure is applied from inside the battery case at the side portions (wide side portions) corresponding to the long sides of its cross-sectional shape. One reason why the capacity is lowered due to the battery swelling is in that when the battery swells, a clearance is formed between the battery case and the electrode group, causing a dent on the electrode group.

Moreover, a prismatic battery, in which a flat electrode group having curved side ends is accommodated in a prismatic battery case, has a problem in that dead space is created particularly at the corners of the battery case, and the energy density is lowered.

In order to cope with these problems, Patent Literature 1 suggests that a plurality of cylindrical electrode groups be accommodated in one prismatic battery case, thereby to produce a prismatic battery without using a flat electrode group. By using a cylindrical electrode group only, the tightening pressure of the electrode group in a prismatic become uniform.

Patent Literature 2 proposes forming an electrode group by: folding a belt-like positive electrode, a belt-like negative electrode, and a belt-like separator together at least once such that the positive electrode is on the positive electrode, and the negative electrode is on the negative electrode; and accommodating the electrode group thus formed in a battery case. By folding the electrode group as above, the dead space in the battery case is reduced, and the energy density can be increased.

### CITATION LIST

### Patent Literature

[PTL 1] Japanese Laid-Open Patent Publication No. 2008-210729
[PTL 2] Japanese Laid-Open Patent Publication No. Hei 5-101830

### SUMMARY OF INVENTION

### Technical Problem

However, as proposed by Patent Literature 1, when a plurality of cylindrical electrode groups are accommodated in one prismatic battery case, the battery case and each electrode group are nearly in line contact with each other, and the contact area therebetween is small. Because of this, the outer peripheries of the electrode groups cannot be pressed with the inner surface of the battery case, failing to sufficiently suppress the swelling of the electrode groups. Moreover, since cylindrical electrode groups are accommodated in a prismatic battery case, a comparatively large dead space is unavoidably created, which makes it difficult to achieve a higher energy density. In addition, due to the necessity of filling the dead space with electrolyte, electrolyte is required in an amount more than necessary for power generation.

As proposed by Patent Literature 2, when an electrode group is folded and accommodated in a battery case, the electrodes are folded by 180 degrees at the bent portions of the folds, which is considered to cause deterioration of the electrodes or long-term deterioration in battery characteristics. Moreover, forming an electrode group by folding electrodes is considered disadvantageous for achieving a higher energy density because the tightening pressure cannot be increased as compared when forming an electrode group by winding.

The present invention has been made in view of the above problems, and intends to provide a prismatic non-aqueous electrolyte secondary battery in which the swelling of the electrode groups due to repetitive charge and discharge can be suppressed, and which allows a higher energy density to be easily achieved.

### Solution to Problem

A non-aqueous electrolyte secondary battery of the present invention includes a plurality of flat electrode groups, a non-aqueous electrolyte, and a prismatic case accommodating the electrode groups and the non-aqueous electrolyte. The electrode groups each include a positive electrode, a negative electrode, and a separator, and the positive electrode, the negative electrode, and the separator are wound into a flat shape. The case has a rectangular cross-sectional shape. The electrode groups are accommodated in the case such that the lateral directions of cross-sectional shapes of the electrode groups are each perpendicular to the lateral direction of the cross-sectional shape of the case, and the axis directions of the electrode groups are each parallel with the height direction of the case.

In other words, the non-aqueous electrolyte secondary battery of the present invention is characterized in that: a plurality of electrode groups each formed by winding a positive electrode and a negative electrode, with a separator interposed therebetween, into a flat shape are stacked and accommodated together with a non-aqueous electrolyte in a prismatic battery case; and the electrode groups are arranged such that, in the cross-sectional shape of the battery case, the lateral directions of the flat electrode groups are substantially perpendicular to the lateral direction of the battery case.

[Advantageous Effects of Invention]

According to the non-aqueous electrolyte secondary battery of the present invention, the swelling of the electrode groups due to repetitive charge and discharge can be suppressed, and a higher energy density can be easily achieved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 An oblique view illustrating an appearance of a non-aqueous electrolyte secondary battery according to one embodiment of the present invention

FIG. 2 An oblique view illustrating an appearance of an electrode group of the non-aqueous electrolyte secondary battery of FIG. 1

FIG. 3 A cross-sectional view of the electrode group of the non-aqueous electrolyte secondary battery of FIG. 1

FIG. 4 A cross-sectional view schematically illustrating a cross-sectional shape of the electrode group of the non-aqueous electrolyte secondary battery of FIG. 1

FIG. 5 A cross-sectional view schematically illustrating a cross-sectional shape of a battery case of the non-aqueous electrolyte secondary battery of FIG. 1

FIG. 6 A cross-sectional view schematically illustrating an inner structure of the non-aqueous electrolyte secondary battery of FIG. 1

FIG. 7 A set of schematic illustrations showing a connection relationship between a plurality of electrode groups in the non-aqueous electrolyte secondary battery of FIG. 1

FIG. 8 A cross-sectional view schematically illustrating a structure of an electrode group of a non-aqueous electrolyte secondary battery according to another embodiment of the present invention

FIG. 9 A schematic illustration of an exemplary apparatus for forming the electrode group of the non-aqueous electrolyte secondary battery of FIG. 8

FIG. 10 A cross-sectional view schematically illustrating an inner structure of a non-aqueous electrolyte secondary battery according to yet another embodiment of the present invention

FIG. 11 A cross-sectional view schematically illustrating an inner structure of a non-aqueous electrolyte secondary battery according to still another embodiment of the present invention

FIG. 12 A cross-sectional view schematically illustrating an inner structure of a non-aqueous electrolyte secondary battery according to still yet another embodiment of the present invention

FIG. 13 A cross-sectional view schematically illustrating an inner structure of the conventional non-aqueous electrolyte secondary battery

### DESCRIPTION OF EMBODIMENT

A non-aqueous electrolyte secondary battery of the present invention includes: a plurality of electrode groups each including a positive electrode, a negative electrode, and a separator which are wound into a flat shape; a non-aqueous electrolyte; and a prismatic case accommodating the electrode groups and the non-aqueous electrolyte. The cross-sectional shape of the case is rectangular with the length in the lateral direction denoted by L1 and the length in the longitudinal direction denoted by L2, where L1<L2. The electrode groups are accommodated in the case such that the lateral directions of the cross-sectional shapes of the electrode groups are each perpendicular to the lateral direction of the cross-sectional shape of the case, and the axis directions of the electrode groups are each parallel with the height direction of the case. It is to be noted that the electrode groups are not individually accommodated in a battery case, but are accommodated in one single battery case so as to be in contact with the same non-aqueous electrolyte. It is to be noted that the terms “perpendicular to” and “parallel with” as used herein may not be mathematically accurate, and may be substantially “perpendicular to” and “parallel with”, including a certain degree of permissible range (e.g., from 70 to 110° when “perpendicular to”; and from 0 to 20° when “parallel with”).

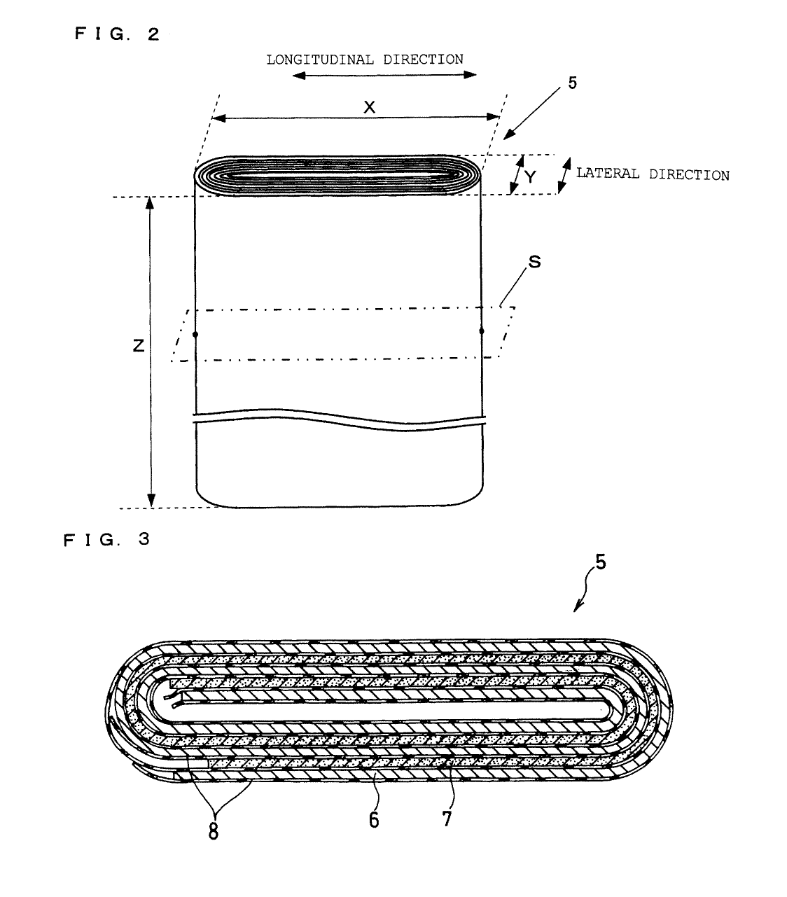

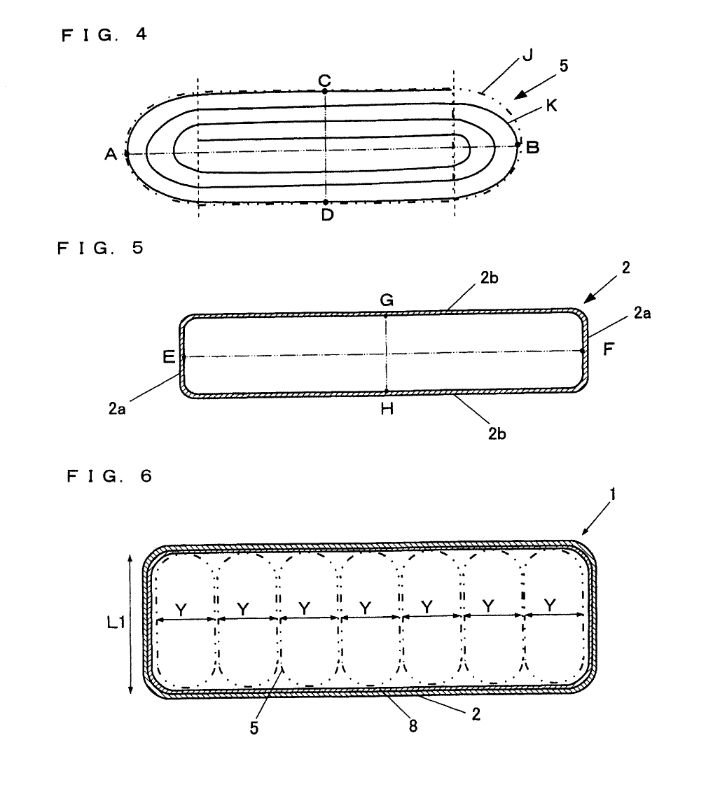

For example, when the electrode group is formed by winding belt-like (long rectangular) positive electrode, negative electrode and separator in the longitudinal direction (see FIG. 2), the cross-sectional shape of the electrode group refers to the shape of a cross section of the electrode group cut along a plane (e.g., a plane S in FIG. 2) perpendicular to the width direction of the positive electrode, negative electrode and separator. The width direction is indicated by “Z” in FIG. 2, or the same direction as the axis direction of the electrode group. In the cross-sectional shape of the flat electrode group, for example, like a shape J in FIG. 4, the two side ends are curved, and the intermediate portion therebetween has a substantially uniform thickness. Here, a length X in the longitudinal direction of the cross-sectional shape of the electrode group (see FIG. 2) is, for example, the length of line segment AB connecting vertices A and B of the side ends in FIG. 4. Hereinafter, the longitudinal direction of the cross-sectional shape of the electrode group is referred to as the “width direction of the electrode group”, and the length X is simply referred to as the “width of the electrode group”.

A length Y in the lateral direction of the cross-sectional shape of the electrode group is the length of a line segment (e.g., line segment CD in FIG. 4) representing the thickness of this cross-sectional shape being flat. In this example, straight line CD is a perpendicular bisector of line segment AB. Hereinafter, the lateral direction of the cross-sectional shape of the electrode group is referred to as the “thickness direction of the electrode group”, and the length Y is simply referred to as the “thickness of the electrode group”.

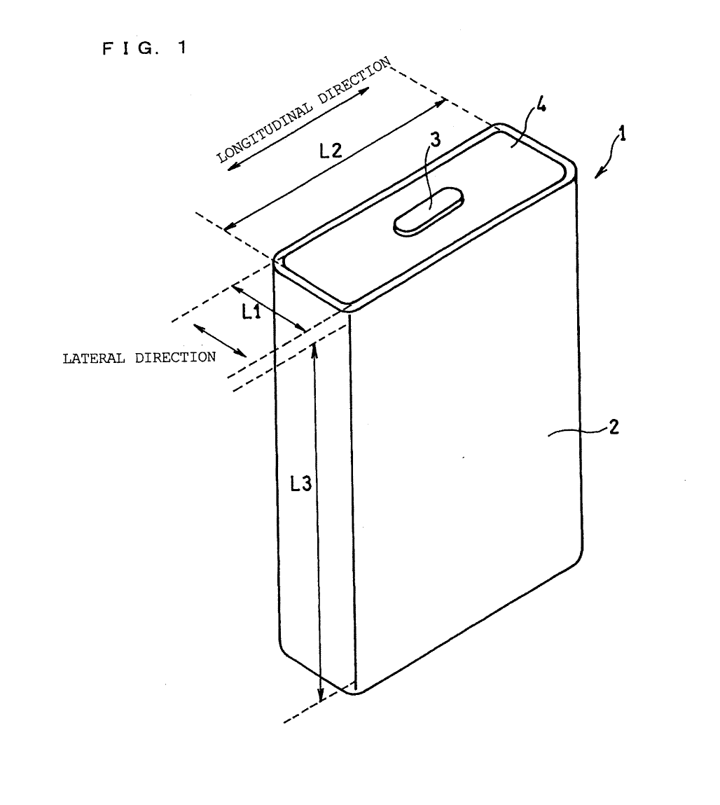

The cross-sectional shape of the case refers to a shape of a cross section of the case cut along a plane perpendicular to the height direction (the top-down direction in FIG. 1) of the battery case. The cross-sectional shape of the case is, for example, rectangular as illustrated in FIG. 5. Here, the “rectangular” shape as used herein includes a rectangular shape with four chamfered corners as illustrated in FIG. 5. The length of the case (hereinafter simply referred to as the “width of the case”) in the longitudinal direction of the cross-sectional shape thereof (hereinafter referred to as the “width direction of the case”) is, for example, the length of line segment EF in FIG. 5. The length of the case (hereinafter simply referred to as the “thickness of the case”) in the lateral direction of the cross-sectional shape thereof (hereinafter referred to as the “thickness direction of the case”) is, for example, the length of line segment GH in FIG. 5. In this example, straight line GH is a perpendicular bisector of line segment EF.

In the present specification, of four side portions of the battery case, a pair of side portions that are larger in width and correspond to a pair of long sides of the cross-sectional shape are referred to as “wide side portions”, and a pair of side portions that are smaller in width and correspond to a pair of short sides of the cross-sectional shape are referred to as “narrow side portions”.

FIG. 13 is a cross-sectional view schematically illustrating an inner structure of the conventional prismatic battery. In a battery 101 of FIG. 13, one flat electrode group 103 is inserted in a battery case 102 along the shape of the battery case 102. As a result, the width direction of the battery case 102 is in parallel with the width direction of the electrode group 103, the thickness direction of the battery case 102 is in parallel with the thickness direction of the electrode group 103, and the height direction of the battery case 102 is in parallel with the axis direction of the electrode group 103.

Generally, a prismatic battery can be freely designed into a shape that can be easily mounted on a device, according to the shape of the device. As for the electrode group for a prismatic battery, the width and length of each electrode plate, the number of winding of the electrode plates, and the like are designed according to the shape of the case of the battery. Specifically, with taken into consideration the inside dimensions of the battery case and the clearance when inserting the electrode group into the battery case, the outside dimensions of the electrode group are designed.

In a prismatic battery, the resistance to the pressure applied from inside the battery case is different between at the wide side portions and at the narrow side portions. In short, the pressure resistance of the narrow side portions is high, while the pressure resistance of the wide side portions is low. When the thicknesses of the side walls of the battery case are reduced in order to increase the energy density of the battery, the pressure resistance of the wide side portions becomes further low.

A flat electrode group, when swelling due to repetitive charge and discharge, is less likely to swell in its width direction because of the large tightening pressure in this direction, while it is more likely to swell in its thickness direction because of the small tightening pressure in this direction. When the thicknesses of the current collectors are reduced in order to increase the energy density of the battery, the electrode group becomes more likely to swell in its thickness direction.

In other words, in a prismatic battery, as the energy density of the battery is made higher and higher, the swelling of the electrode group due to repetitive charge and discharge becomes noticeable at the wide side portions of the battery case.

In contrast, according to the present invention, as illustrated in FIGS. 6 and 10 to 12, a plurality of flat electrode groups are accommodated in a battery case such that the thickness direction of each electrode group is perpendicular to the thickness direction of the battery case, and the width direction of each electrode group is perpendicular to the width direction of the battery case. By configuring as above, of two pairs of side portions of the prismatic battery case, the narrow side portions, which are highly resistant to the pressure applied from inside and are unlikely to deform, can compress the swelling of each flat electrode group in its thickness direction.

On the other hand, the wide side portions of the battery case, which are less resistant to the pressure applied from inside, are perpendicular to the width directions of the flat electrode groups, in which direction the electrode groups are unlikely to swell because of the large tightening pressure. As a result of the foregoing, the swelling of the battery as a whole can be suppressed.

Furthermore, not one electrode group but a plurality of flat electrode groups each having a fraction of the size of the battery case are accommodated in one prismatic battery case. As such, dead space which tends to be created particularly at the corners of the battery case can be easily reduced. Therefore, there is no need of injecting electrolyte in an amount more than necessary for power generation to fill the dead space, which results in cost reduction. In addition, due to the smaller dead space within the case, a higher energy density can be practically achieved.

In one embodiment of the present invention, at least two of the electrode groups are connected in parallel with each other. By accommodating a plurality of electrode groups connected in parallel with each other in one battery case, a large current and a high power output can be easily obtained.

In another embodiment of the present invention, at least two of the electrode groups are connected in series with each other. By accommodating a plurality of electrode groups connected in series with each other in one battery case, a high voltage and a high power output can be easily obtained.

In yet another embodiment of the present invention, the electrode groups include at least two electrode groups connected in parallel with each other and at least two electrode groups connected in series with each other. In this case, the electrode groups include three or more electrode groups. And, at least two of the electrode groups are connected in parallel with each other, with which at least one of the other electrode groups is connected in series. Alternatively, two or more sets of electrode groups connected in parallel may be connected in series with each other. Alternatively, two or more sets of electrode groups connected in series may be connected in parallel with each other. In this case, the number of the electrode groups connected in series included in one set must be equal to that in another set connected therewith in parallel. By configuring as above, the current and voltage of the battery can be optimally designed according to its application.

In still another embodiment of the present invention, in at least two of the electrode groups, the positive electrode, the negative electrode, and the separator are each continuous in one. By using one continuous positive electrode, one continuous negative electrode, and one continuous separator to form two or more electrode groups as above, two or more electrode groups can be formed continuously by one winding process. As a result, it becomes unnecessary to provide every electrode group with a lead, and the number of processes and the number of component parts can be decreased. Moreover, when using a plurality of electrode groups formed of electrode plates and the like each being one continuous member, it is not necessary to perform a process of stacking the individual electrode groups into one block, and therefore, the number of processes can be decreased, resulting in the reduction of production costs.

In still yet another embodiment of the present invention, the ratio of a length in the longitudinal direction to a length in the lateral direction of the cross-sectional shape of at least one of the electrode groups is smaller than the ratio of a length in the longitudinal direction to a length in the lateral direction of the cross-sectional shape of the case. By this configuration, the electrode groups can have relatively large thicknesses, and thus the number of electrode groups to be accommodated in one prismatic battery case can be decreased, making it possible to stack and accommodate a plurality of electrode groups efficiently in one prismatic battery case.

In further another embodiment of the present invention, at least one of the electrode groups is different from another one of the electrode groups in term of the length in the lateral direction of the cross-sectional shape. By using electrode groups different from each other in the thickness of the cross-sectional shape in combination, even if the integral multiple of the thickness of an electrode group is not equal to the width of the battery case, a plurality of flat electrode groups can be accommodated in a prismatic battery case such that the dead space becomes as small as possible. This results in a higher energy density of the battery.

In further yet another embodiment of the present invention, the electrode groups include two or more row elements. The row elements each comprise two or more electrode groups arranged in a row in the longitudinal direction of the cross-sectional shape of the case. The two or more row elements are arranged side by side in the lateral direction of the cross-sectional shape of the case. In this case, the electrode groups include four or more electrode groups. As such, the electrode groups are accommodated in the battery case so as to be arranged both in the width and thickness directions of the battery case. Consequently, even when the size of the electrode group that can be used is specified in advance, a plurality of flat electrode groups can be accommodated in a prismatic battery case so that the dead space becomes as small as possible, while the width and thickness of the prismatic battery case are comparatively freely set. This results in a further higher energy density. This also produces an effect to increase the degree of freedom in designing a battery.

In further still another embodiment of the present invention, the lengths in the longitudinal directions of the cross-sectional shapes of the electrode groups constituting at least two row elements adjacent to each other in the lateral direction of the cross-sectional shape of the case are different from one another. By configuring as above, when a plurality of electrode groups are arranged in a matrix with rows and columns in the battery case, even if the integral multiple of the width of one electrode group is not equal to the thickness of the battery case, a plurality of flat electrode groups can be accommodated in a prismatic battery case such that the dead space becomes as small as possible. It is therefore possible to easily produce a prismatic battery having a shape that matches the shape of the battery-mounting space in a device. This increases the degree of freedom in designing a battery, and enables an easy production of a high capacity prismatic battery that is applicable where the battery-accommodating spaces cannot be integrated into one in an electric vehicle etc.

Embodiments of the non-aqueous electrolyte secondary battery of the present invention are described in detail below, with reference to the drawings appended hereto.

### Embodiment 1

FIG. 1 is an oblique view illustrating an appearance of a non-aqueous electrolyte battery according to one embodiment of the present invention. FIG. 2 is an oblique view of an electrode group to be accommodated in the battery of FIG. 1.

A battery 1 shown in the figure is a prismatic battery including a battery case 2 of a flat prismatic shape. The battery case 2 accommodates a plurality of flat electrode groups 5 as shown in FIG. 2 (see FIG. 6), and is filled with a non-aqueous electrolyte (not shown). The reference sings L1, L2 and L3 in FIG. 1 denote the length in the longitudinal direction (the width of the battery case) and the length in the lateral direction (the thickness of the battery case) of the cross-sectional shape of the battery case 2, and the height of the battery case 2, respectively, as the inside dimensions of the battery case 2.

In the battery 1, a sealing plate 4 provided with a protrusion 3 serving as a negative terminal is laser-welded to the opening end of the one-end-open battery case 2 obtained by drawing process, to seal the opening of the battery case 2. The sealing plate 4 includes a safety mechanism comprising a PTC element and an explosion prevention valve (both not shown). The reference sings X, Y and Z in FIG. 2 denote the length in the longitudinal direction (the width of the electrode group) and the length in the lateral direction (the thickness of the electrode group) of the cross-sectional shape of the flat electrode group 5, and the length in the axis direction of the electrode group 5, respectively.

FIG. 3 is a cross-sectional view of the electrode group. This cross-sectional view is a sectional view of the electrode group 5 of FIG. 2 cut along a plane S. The plane S is a plane perpendicular to the axis direction (Z-direction) of the electrode group 5. The electrode group 5 shown in the figure is configured by winding into a flat shape: a positive electrode plate 6 including a belt-like positive electrode current collector (not shown), and positive electrode active material layers (not shown) formed on both surfaces thereof and containing a positive electrode active material; a negative electrode plate 7 including a belt-like negative electrode current collector (not shown), and negative electrode active material layers (not shown) formed on both surfaces thereof and containing a negative electrode active material; and two belt-like separators 8 each interposed between the positive and negative electrode plates as an insulator.

More specifically, in the electrode group 5 shown in the figure, the belt-like positive electrode plate 6 is sandwiched between the two belt-like separators 8, with the belt-like negative electrode plate 7 attached thereto on the outside, and in this state, these four members are wound. A positive electrode lead and a negative electrode lead (both not shown), which are electrically conductive with outer terminals, are connected to the positive electrode plate 6 and the negative electrode plate 7, respectively.

The negative electrode lead is connected to the protrusion 3 electrically insulated from the sealing plate 4. This allows the protrusion 3 to serve as a negative outer terminal of the battery 1. The positive electrode lead is connected to the sealing plate 4. The sealing plate 4 is electrically conductive with the battery case 2, and the battery case 2 and the sealing plate 4 serve as a positive outer terminal of the battery 1.

FIG. 4 is a further schematic illustration of the cross section of the electrode group shown in FIG. 3. In FIG. 4, the four members: the two separators 8, the positive electrode plate 6 sandwiched therebetween, and the negative electrode plate 7 attached thereto on the outside, are collectively shown by one continuous curve. Hereinafter, the four members are collectively referred to as a member group K. In the figure, a closed curve J is an outline of a cross-sectional shape of the electrode group 5. As shown by the curve J, the cross-sectional shape of the electrode group 5 has two curved side ends and an intermediate portion therebetween having a substantially uniform thickness. Here, the width X of the electrode group 5 is, for example, the length of line segment AB connecting vertices A and B of the side ends in FIG. 4. The thickness Y of the electrode group is the length of line segment CD representing the thickness of the above cross-sectional shape. Straight line CD is a perpendicular bisector of line segment AB.

FIG. 5 is a schematic illustration of the cross-sectional shape of the battery case. The cross-sectional shape of the battery case 2 is the shape of a cross section of the battery case 2 cut along a plane perpendicular to the height direction (the top-down direction in FIG. 1) of the battery case 2. The cross-sectional shape of the battery case 2 shown in the figure is rectangular. The width of the battery case 2 is the length of line segment EF. Points E and F are midpoints of sides (short sides) corresponding to the pair of narrow side portions 2a. The thickness of the battery case 2 is the length of line segment GH. Straight line GH is a perpendicular bisector of segment EF. In other words, points G and H are midpoints of sides (long sides) corresponding to the pair of wide side portions 2b.

FIG. 6 illustrates an inner structure of the non-aqueous electrolyte secondary battery of Embodiment 1. In the battery 1 shown in the figure, the electrode groups 5 are stacked and accommodated in the battery case 2 such that the thickness direction of the battery case 2 and the thickness direction of each of a plurality of (seven in the figure) the electrode groups 5 are perpendicular to each other.

For example, prior to being accommodated in the battery case 2, the electrode groups 5 are preferably bound together with another separator 8, so that the electrode groups 5 can be held in a stacked state in their thickness directions. By doing this, the electrode groups 5, in a bound state with the separator 8, can be accommodated in the battery case 2. As a result, the process of accommodating the electrode groups 5 in the battery case 2 can be simplified and carried out in a shorter time. FIG. 6 shows an example in which the electrode groups 5 are bound with one sheet of another separator 8 and accommodated in the battery case 2. When the electrode groups 5 are accommodated one by one in the battery case 2, it is not necessary to use the separator 8 as above.

Here, given that the clearance is neglected, the width X of each electrode group 5 is equal to the inside thickness L1 of the battery case 2. Likewise, the inside width L2 of the battery case 2 is equal to an integral multiple (seven times in the figure) of the thickness Y of each electrode group 5.

According to the configuration above, the thickness direction of the electrode group 5, in which direction the resistance to swelling is low and swelling is likely to occur, is directed to the narrow side portions 2a of the battery case 2 where the resistance to pressure is high. The width direction X of the electrode group 5, in which direction the resistance to swelling is high and swelling is unlikely to occur, is directed to the wide side portions 2b of the battery case 2 where the resistance to pressure is low. Therefore, the swelling of the prismatic battery due to repetitive charge and discharge can be suppressed.

In the battery 1, the ratio: X/Y of the width X to the thickness Y of each electrode group 5 is preferably smaller than the ratio: L2/L1 of the width L2 to the thickness L1 of the battery case 2. In other words, the electrode groups 5 and the battery case 2 satisfy the following formula (1):

X/Y<L2/L1 (1).

When the formula (1) is satisfied, the thickness Y relative to the width X of each electrode group 5 is large, as compared with the thickness L1 relative to the width L2 of the battery case 2. Therefore, the number of the electrode groups 5 to be accommodated in one battery case 2 can be decreased, and the accommodation of the plurality of electrode groups 5 in the prismatic battery case 2 can be effectively conducted.

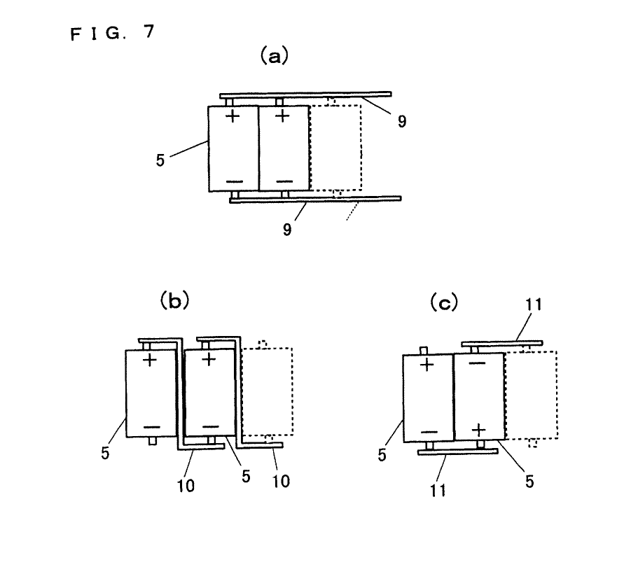

FIG. 7 illustrates examples of the electrical connection relationship between the electrode groups 5. As described above, a positive electrode lead and a negative electrode lead are welded to the positive electrode plate 6 and the negative electrode plate 7 of each electrode group 5, respectively.

In FIG. 7(a), the positive electrode leads of two electrode groups 5 adjacent to each other are both arranged on the upper side, and the negative electrode leads of two electrode groups 5 adjacent to each other are both arranged on the lower side. The positive electrode leads are connected to each other via a conductor 9, and the negative electrode leads are connected to each other via another conductor 9. At least two electrode groups 5 are thus connected in parallel. As a result, battery characteristics of large current and high power output can be easily achieved.

In FIG. 7(b), the positive electrode leads of two electrode groups 5 adjacent to each other are both arranged on the upper side, and the negative electrode leads of two electrode groups 5 adjacent to each other are both arranged on the lower side. The positive electrode lead of one of the two electrode groups 5 (the electrode group 5 on the left side of the figure) is connected via a conductor 10 to the negative electrode lead of the other one of the two electrode groups 5 (the electrode group 5 on the right side of the figure). At least two electrode groups 5 are thus connected in series. As a result, battery characteristics of high voltage and high power output can be easily achieved.

In FIG. 7(c), the positive electrode lead of one of two electrode groups 5 adjacent to each other (the electrode group 5 on the left side of the figure) is arranged on the upper side, and the positive electrode lead of the other (the electrode group 5 on the right side of the figure) is arranged on the lower side. The negative electrode lead of one of the two electrode groups 5 adjacent to each other is arranged on the lower side, and the negative electrode lead of the other is arranged on the upper side. The negative electrode lead of one of the two electrode groups 5 is connected to the positive electrode lead of the other electrode group 5. At least two electrode groups 5 are thus connected in series. As a result, battery characteristics of large current and high power output can be easily achieved.

The electrode groups 5 may be connected to each other by combining the above-described series connection and parallel connection, to provide a battery whose large current characteristics and high voltage characteristics are optimally designed according to the application of the battery. For example, two or more sets of parallel-connected electrode groups 5 may be connected to each other in series, or alternatively, two or more sets of parallel-connected electrode groups 5 may be connected in series with at least one of the other electrode groups 5. Alternatively, two or more sets of series-connected electrode groups 5 may be connected to each other in parallel.

### Embodiment 2

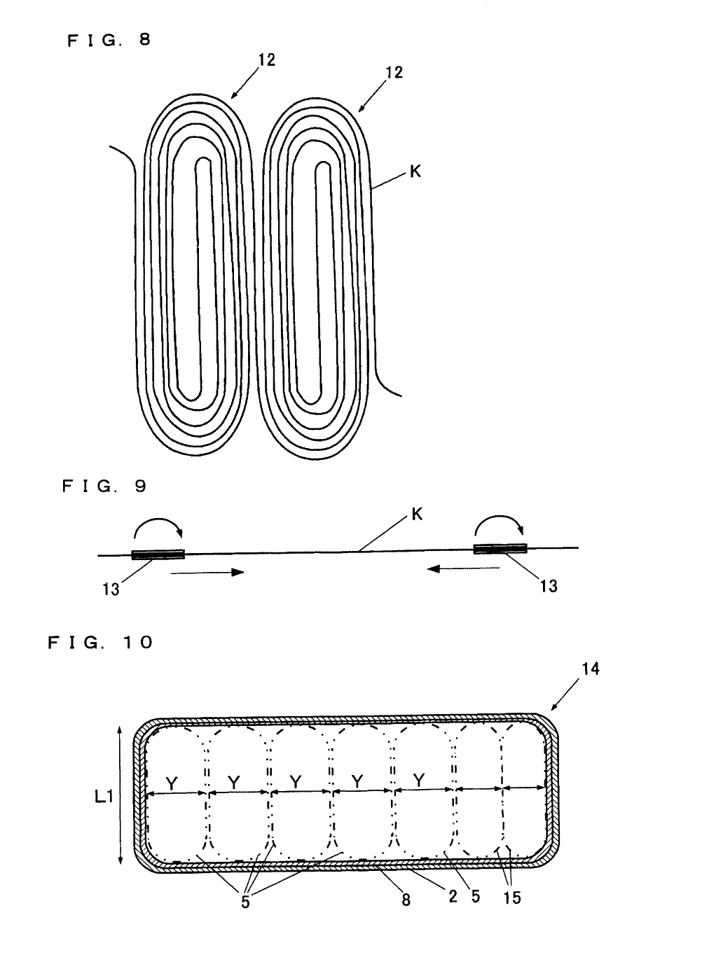

FIG. 8 is a schematic illustration of an electrode group used in a non-aqueous electrolyte secondary battery of Embodiment 2. In FIG. 8, as in FIG. 4, four members: two separators 8, the positive electrode plate 6 and the negative electrode plate 7, are shown by one continuous curve. They are referred to as the member group K.

As illustrated in FIG. 8, in Embodiment 2, among the electrode groups arranged as illustrated in FIG. 6, at least two electrode groups 12 adjacent to each other are constituted from the positive electrode plate 6, the negative electrode plate 7 and the separators 8, each made of one continuous member. By configuring the electrode groups as above, two or more flat electrode groups 12 can be formed by one winding process. As a result, it becomes unnecessary to include the process of providing every electrode group with a lead, or bundling the individual electrode groups into one stack using the separator 8 etc. Therefore, the production costs can be reduced.

As illustrated in FIG. 9, the electrode groups 12 can be formed by using at least two winding cores 13 arranged apart from each other with a predetermined distance therebetween. For example, while one member group K is wound with these winding cores 13 at different positions by rotating them in the same direction, the winding cores 13 are moved nearer to each other. The electrode groups 12 can be thus formed. The winding cores 13 may each comprise two thin plate-like members which are arranged in parallel so as to sandwich the member group K. In FIG. 9, although the member group K further extends to the right and left in the figure, the extending portions are not shown.

### Embodiment 3

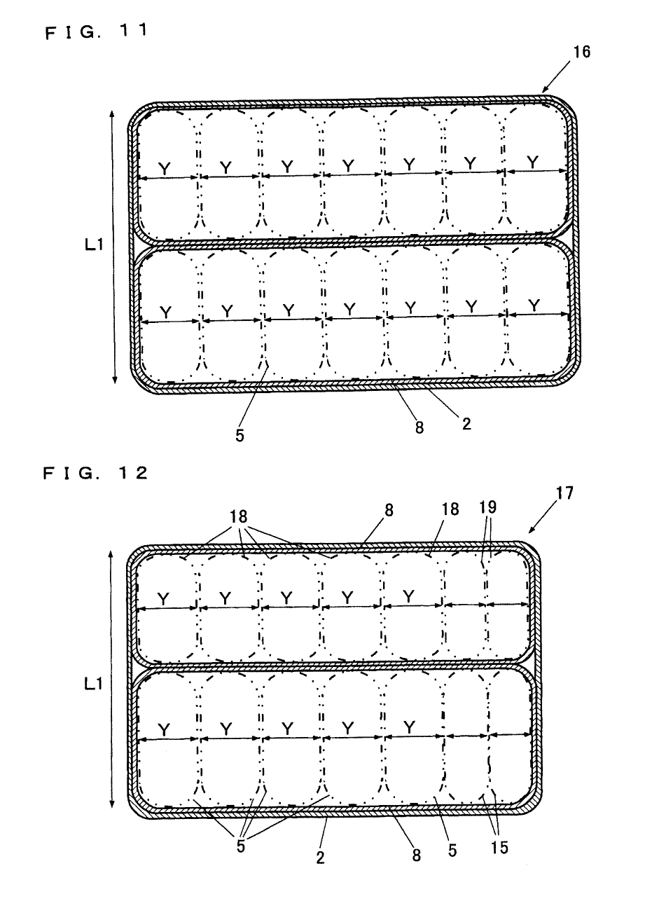

FIG. 10 is a cross-sectional view illustrating an inner structure of a non-aqueous electrolyte secondary battery according of Embodiment 3 of the present invention. In a battery 14 illustrated in the figure, the battery case 2 accommodates two or more types (two types in the figure) of flat electrode groups 5 and 15 differing in thickness. In the battery 14 also, as in Embodiments 1 and 2, the thickness directions of all the electrode groups 5 and 15 are perpendicular to the thickness direction of the battery case 2, and the axis directions of all the electrode groups 5 and 15 are parallel with the height direction of the battery case 2.

The width of the electrode group 15 is the same as that of the electrode group 5, but the thickness of the electrode group 15 is different from that of the electrode group 5. The thickness of the electrode group 15 may be smaller or larger than that of the electrode group 5. In the battery 14 shown in the figure, the thickness of the electrode group 15 is smaller than that of the electrode group 5. The number of types of the electrode groups with different thicknesses is not limited to two types, and may be three or more types.

According to the configuration above, even if the inside width L2 of the battery case 2 is not equal to the integral multiple of the thickness X of a flat electrode group, a plurality of flat electrode groups can be accommodated in a prismatic battery case, with the dead space being efficiently reduced. It is to be noted that, even between the electrode groups 5 and 15 differing in thickness, continuous electrode plates and the like can be used as in Embodiment 2 (see FIG. 8).

### Embodiment 4

FIG. 11 is a cross-sectional view illustrating an inner structure of a non-aqueous electrolyte secondary battery of Embodiment 4 of the present invention. In a battery 16 shown in the figure, a plurality of the electrode groups 5 are stacked not only in the width direction of the battery case 2 but also in the thickness direction thereof. Two or more electrode groups 5 arranged in the width direction of the battery case 2 constitute a row element. In the thickness direction of the battery case 2, two or more (two in the figure) row elements are arranged side by side. In the battery 16, the thickness directions of all the electrode groups 5 are perpendicular to the thickness direction of the battery case 2, and the axis directions of all the electrode groups 5 are parallel with the height direction of the battery case 2.

According to the configuration above, even if the thickness of the battery case 2 is not so small as compared with the width thereof, that is, even if the cross-sectional shape of the battery case 2 is nearly a square, the flat electrode groups 5 can be accommodated in the battery case 2, with the dead space being efficiently reduced. As a result, a further higher energy density of the prismatic battery can be achieved. It is to be noted that in the battery 16 of Embodiment 4, even among two or more electrode groups arranged in the thickness direction of the battery case 2, continuous electrode plates and the like can be used as in Embodiment 2. Furthermore, the thicknesses of the electrode groups constituting a row element may not be the same, and several types of flat electrode groups differing in thickness may be used, as in FIG. 10.

### Embodiment 5

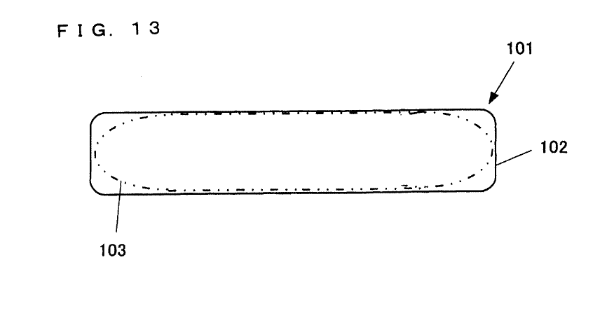

FIG. 12 is a cross-sectional view illustrating an inner structure of a non-aqueous electrolyte secondary battery of Embodiment 5 of the present invention. In a battery 17 shown in the figure also, as in Embodiment 4, the electrode groups are stacked both in the width and thickness directions of the battery case 2. The battery 17 differs from the battery 16 in that: in the width direction of the battery case 2, two or more types (two types in the figure) of flat electrode groups differing in thickness are stacked; and in the thickness direction of the battery case 2 also, two or more types (two types in the figure) of flat electrode groups differing in width are stacked.

In other words, in the battery 17, the electrode groups are arranged in two rows in the thickness direction of the battery case (the top-down direction in the figure), and in the row (row element) on the lower side, two types of electrode groups 5 and 15 differing in thickness are mixed and stacked. On the other hand, in the row (row element) on the upper side, two types of electrode groups 18 and 19 differing in thickness are mixed and stacked. The electrode groups 18 and 5 arranged in the top-down direction have the same thickness but have different widths. In the figure, the width of the electrode group 18 is smaller than that of the electrode group 5.

Likewise, the electrode groups 19 and 15 arranged in the top-down direction have the same thickness but have different widths. In the figure, the width of the electrode group 19 is smaller than that of the electrode group 15. In the battery 17 also, the thickness directions of all the electrode groups 5, 15, 18 and 19 are perpendicular to the thickness direction of the battery case 2, and the axis directions of all the electrode groups 5, 15, 18 and 19 are parallel with the height direction of the battery case 2. As in each Embodiment described above, continuous electrode plates or the like can be used for these electrode groups. Likewise, the number of types of the electrode groups with different widths may be three or more types.

According to the configuration above, whatever the width and thickness of the battery case 2 are, the dead space can be reduced to be as small as possible. Therefore, a further higher energy density of the prismatic battery can be achieved. As a result, it becomes unnecessary to inject electrolyte in an amount more than necessary for power generation, into the battery case 2.

A detailed description is given below of each component of the non-aqueous electrolyte secondary battery.

(Positive Electrode)

The positive electrode comprises, for example, a sheet-like positive electrode current collector and a positive electrode material mixture layer adhering to a surface of the positive electrode current collector. A publicly known positive electrode current collector for non-aqueous electrolyte secondary batteries, such as a metal foil made of aluminum, an aluminum alloy, stainless steel, titanium, or a titanium alloy, may be used as the positive electrode current collector. The material of the positive electrode current collector may be selected as appropriate in view of the processability, the practical strength, the adhesion with the positive electrode material mixture layer, the electron conductivity, the corrosion resistance, and other factors. The thickness of the positive electrode current collector is, for example, 1 to 100 μm, and preferably 10 to 50 μm.

The positive electrode material mixture layer contains a positive electrode active material, and may further contain, for example, a conductive agent, a binder, and a thickener. The positive electrode active material is, for example, a lithium-containing transition metal compound capable of receiving lithium ion as a guest. Examples of the lithium-containing transition metal compound include composite metal oxides of lithium and at least one metal selected from cobalt, manganese, nickel, chromium, iron, and vanadium, such as LiCoO₂, LiMn₂O₄, LiNiO₂, LiCoₓNi₁₋ₓO₂ where 0<x<1, LiCo_{y}M_{1-y}O₂ where 0.6≦y<1, LiNi_{z}M_{1-z}O₂ where 0.6≦z<1, LiCrO₂, αLiFeO₂, and LiVO₂. In the above formulae, M represents at least one element (particularly, Mg and/or Al) selected from the group consisting of Na, Mg, Sc, Y, Mn, Fe, Co, Ni, Cu, Zn, Al, Cr, Pb, Sb, and B. These positive electrode active materials may be used singly or in combination of two or more.

The binder may be any binder that can be dissolved in or dispersed into a dispersion medium by kneading. Examples of the binder include fluorocarbon resin, rubbers, acrylic polymer, and vinyl polymer (e.g., an acrylic monomer such as methyl acrylate or acrylonitrile, a vinyl monomer such as vinyl acetate, and copolymers of these monomers). Examples of the fluorocarbon resin include polyvinylidene fluoride (PVDF), a copolymer of vinylidene fluoride and hexafluoropropylene, and polytetrafluoroethylene (PTFE). Examples of the rubbers include acrylic rubber, modified acrylonitrile rubber, styrene-butadiene rubber (SBR), isopropylene rubber, butadiene rubber, and ethylene-propylene-diene polymer (EPDM). These binders may be used singly or in combination of two or more. The binder may be used in the form of a dispersion in which the binder is dispersed in a dispersion medium.

Examples of the conductive agent include: carbon blacks, such as acetylene black, Ketjen black, channel black, furnace black, lamp black, and thermal black; and various graphites, such as natural graphite and artificial graphite; and conductive fibers, such as carbon fibers and metal fibers.

A thickener may be added as needed. Examples of the thickener include ethylene-vinyl alcohol copolymers, and cellulose derivatives (e.g., carboxymethyl cellulose (CMC), methyl cellulose (MC), hydroxymethyl cellulose (HMC), ethyl cellulose, polyvinyl alcohol (PVA), oxidized starch, phosphorylated starch, and casein).

The dispersion medium is not particularly limited as long as the binder can be dissolved or dispersed therein, and may be either an organic solvent or water (including hot water), depending on the affinity of the binder for the dispersion medium. Examples of the organic solvent include: N-methyl-2-pyrrolidone; ethers, such as tetrahydrofuran; ketones, such as acetone, methyl ethyl ketone, and cyclohexanone; amides, such as N,N-dimethylformamide and dimethylacetamide; sulfoxides, such as dimethylsulfoxide; and tetramethyl urea. These dispersion mediums may be used singly or in combination of two or more.

The positive electrode material mixture layer can be formed by kneading a positive electrode active material, and, as needed, a binder, a conductive agent and/or a thickener, together with a dispersion medium, to prepare a material mixture in a slurry state, and allowing the material mixture to adhere to a positive electrode current collector. Specifically, the material mixture is applied onto a surface of the positive electrode current collector by a known coating method, followed by drying, and, as needed, rolling, whereby a positive electrode material mixture layer can be formed. On part of the positive electrode current collector, there is formed a portion where no positive electrode material mixture layer is formed and the surface of the current collector is exposed. To this exposed portion, a positive electrode lead is welded. The positive electrode is preferably excellent in flexibility.

The material mixture can be applied by using a publicly known coater, such as a slit die coater, reverse roll coater, lip coater, blade coater, knife coater, gravure coater, or dip coater. The applied material mixture is preferably dried under the conditions similar to those for natural drying, and in view of the productivity, it is preferably dried at a temperature ranging from 70° C. to 200° C. for 10 minutes to 5 hours. The material mixture layer may be rolled, for example, by using a roll press machine, at a line pressure of 1000 to 2000 kgf/cm (19.6 kN/cm), and repeating the rolling several times to have a predetermined thickness. In rolling, the line pressure may be changed as needed.

In preparing a material mixture in a slurry state by kneading, other materials such as various dispersers, surfactants, and stabilizers may be added as needed.

The positive electrode material mixture layer may be formed on one surface or both surfaces of the positive electrode current collector. The density of the active material in the positive electrode material mixture layer is 3 to 4 g/ml, and preferably 3.4 to 3.9 g/ml, or 3.5 to 3.7 g/ml, when the active material is a lithium-containing transition metal compound.

The thickness of the positive electrode is, for example, 70 to 250 μm, and preferably, 100 to 210 μm.

(Negative electrode)

The negative electrode comprises, for example, a sheet-like negative electrode current collector and a negative electrode material mixture layer adhering to a surface of the negative electrode current collector. A publicly known negative electrode current collector for non-aqueous electrolyte secondary batteries, such as a metal foil made of copper, a copper alloy, nickel, a nickel alloy, stainless steel, aluminum, or an aluminum alloy may be used as the negative electrode current collector. In view of the processability, the practical strength, the adhesion with the positive electrode material mixture layer, the electron conductivity, and other factors, the negative electrode current collector is preferably copper foil or a copper-alloy metal foil. The current collector may be in any form without limitation, and may be in the form of, for example, rolled foil, electrolytic foil, perforated foil, expanded material, or lath. The thickness of the negative electrode current collector is, for example, 1 to 100 μm, and preferably 2 to 50 μm.

The negative electrode material mixture layer contains a negative electrode active material, and may further contain, for example, a conductive agent, a binder, and a thickener. The negative electrode active material is, for example, a material with a graphite-like crystal structure capable of reversibly absorbing and releasing lithium ions, examples of which include carbon materials, such as natural graphite, spherical or fibrous artificial graphite, non-graphitizable carbon (hard carbon), and graphitizable carbon (soft carbon). Particularly preferred is a carbon material with a graphite-like crystal structure in which the interplanar spacing (d002) between lattice planes (002) is 0.3350 to 0.3400 nm. Other examples thereof include artificial graphites produced by subjecting graphitizable pitches obtained from various raw materials to a high-temperature treatment, purified natural graphite, and materials prepared by subjecting these graphites to various surface treatments with pitch. These graphite materials may be used by being mixed with a negative electrode material capable of absorbing and releasing lithium. Examples of the negative electrode material capable of absorbing and releasing lithium, other than graphite, include metal oxide materials, such as tin oxide and silicon oxide; silicon; silicon-containing compounds, such as silicide; and lithium alloys or various alloy compositions containing at least one selected from tin, aluminum, zinc, and magnesium.

Examples of the silicon oxide include SiO_{α} where 0.05<α<1.95. A preferable range of α is from 0.1 to 1.8, and a more preferable range thereof is from 0.15 to 1.6. In the silicon oxide, silicon may be partially replaced with one element or two or more elements. Examples of such elements include B, Mg, Ni, Co, Ca, Fe, Mn, Zn, C, N, and Sn. These negative electrode materials may be used as a mixture of two or more.

Examples of the binder, conductive agent, thickener and dispersion medium are the same as those exemplified for the positive electrode.

The method for forming the negative electrode material mixture layer may be formed by a publicly known method, without being limited to the aforementioned coating using a binder and other optional components. For example, it may be formed by depositing a negative electrode active material by a vapor phase method such as vacuum vapor deposition, sputtering, or ion plating, on a surface of the current collector. Alternatively, it may be formed by the method similar to that of forming the positive electrode material mixture layer, using a material mixture in a slurry state including a negative electrode active material, a binder, and as needed, a conductive material.

The density of the active material in the negative electrode material mixture layer formed by using a material mixture including a carbon material as the active material is 1.3 to 2 g/ml, preferably 1.4 to 1.9 g/ml, and more preferably 1.5 to 1.8 g/ml.

The thickness of the negative electrode is, for example, 100 to 250 μm, and preferably 110 to 210 μm. The negative electrode preferably has flexibility.

(Separator)

The thickness of the separator may be selected from the range of, for example, 5 to 35 μm, and is preferably 10 to 30 μm, or 12 to 20 μm. When the thickness of the separator is too small, minor short circuits are likely to occur inside the battery. When the thickness of the separator is too large, it becomes necessary to reduce the thicknesses of the positive and negative electrodes, which may result in an insufficient battery capacity.

The material of the separator is preferably a polyolefin-based material, or a combination of a polyolefin-based material and a heat resistant material.

The polyolefin porous film that can be used is, for example, a porous film of polyethylene, polypropylene, or ethylene-propylene copolymer. These resins may be used singly or in combination of two or more. A thermoplastic polymer other than the above may be used, as needed, in combination with polyolefin.

The heat resistant porous film that can be used may be a film composed only of a heat resistant resin or an inorganic filler, or a film composed of a mixture of a heat resistant resin and an inorganic filler.

Examples of the heat resistant resin include: aromatic polyamide (e.g., fully aromatic polyamide), such as polyarylate and aramid; polyimide resin, such as polyimide, polyamide-imide, polyetherimide, and polyester imide; aromatic polyester, such as polyethylene terephthalate; polyphenylene sulfide; polyether nitrile; polyether ether ketone; and polybenzimidazole. These heat resistant resins may be used singly or in combination of two or more. In view of the retention of non-aqueous electrolyte and the heat resistance, aramid, polyimide, and polyamide-imide are preferred.

Examples of the inorganic filler include: metal oxides, such as iron oxide; ceramics, such as silica, alumina, titania, and zeolite; mineral-based fillers, such as talc and mica; carbon-based fillers, such as activated carbon and carbon fiber; nitrides, such as silicon nitride; glass materials, such as glass fibers, glass beads, and glass flakes.

The porosity of the polyolefin porous film (or porous polyolefin layer) is, for example, 20 to 80%, and preferably 30 to 70%.

The porosity of the heat-resistant porous film is, for example, 20 to 70%, and preferably 25 to 65%, for ensuring a sufficient movability of lithium ions.

(Non-Aqueous Electrolyte)

The non-aqueous electrolyte is prepared by dissolving a lithium salt in a non-aqueous solvent. The non-aqueous solvent is preferably at least one selected from: cyclic carbonates such as ethylene carbonate, propylene carbonate, and butylene carbonate; and chain carbonates such as dimethyl carbonate, diethyl carbonate, ethyl methyl carbonate, din-propyl carbonate, methyl n-propyl carbonate, ethyl n-propyl carbonate, methyl i-propyl carbonate, and ethyl i-propyl carbonate, and more preferably, contains ethyl methyl carbonate. The non-aqueous solvent may be a mixture of these. Other examples of the non-aqueous solvent include: lactones, such as γ-butyrolactone; halogenated alkanes, such as 1,2-dichloroethane; alkoxyalkanes, such as 1,2-dimethoxyethane and 1,3-dimethoxypropane; ketones, such as 4-methyl-2-pentanone; ethers, such as 1,4-dioxane, tetrahydrofuran, and 2-methyltetrahydrofuran; nitriles, such as acetonitrile, propionitrile, butyronitrile, valeronitrile, and benzonitrile; sulfolane and 3-methyl-sulfolane; amides, such as dimethylformamide; sulfoxides, such as dimethylsulfoxide; and alkyl phosphates, such as trimethylphosphate and triethylphosphate. These non-aqueous solvents may be used singly or in combination of two or more.

By decreasing the content of propylene carbonate and/or butylene carbonate, which are readily decomposed during charge and discharge, the generation of reducing gas during charge and discharge can be suppressed, and therefore, a non-aqueous electrolyte secondary battery having excellent cycle characteristics can be obtained.

The lithium salt may be those having high electron-withdrawing property, such as LiPF₆, LiBF₄, LiClO₄, LiAsF₆, LiCF₃SO₃, LiN(SO₂CF₃)₂, LiN(SO₂C₂F₅)₂, or LiC(SO₂CF₃)₃. These lithium salts may be used singly or in combination of two or more. The concentration of the lithium salt(s) in the non-aqueous electrolyte is, for example, 0.5 to 1.5 M, or preferably 0.7 to 1.2 M.

The non-aqueous electrolyte may contain an additive as appropriate. Examples of an additive for forming a favorable surface film on the positive and negative electrodes include vinylene carbonate (VC), cyclohexylbenzene (CHB), and modified products of these. Examples of an additive that acts when the lithium ion secondary battery becomes an overcharged state include terphenyl, cyclohexylbenzene, and diphenyl ether. These additives may be used singly or in combination of two or more. The content of the additive(s) is not particularly limited, but is, for example, about 0.05 to 10 wt % relative to the non-aqueous electrolyte.

The battery case has an open upper end. In view of the pressure resistance, the battery case is preferably made of, for example, an aluminum alloy containing a small amount of metal such as manganese or copper, or an inexpensive nickel-plated steel sheet.

Alternatively, the battery case may be a metal laminate. In this option, for example, a molded metal laminate with a recess is used, and flat electrode groups are placed in the recess according to the long sides, short sides, and height of the recess, followed by injecting an electrolyte, and then, the four sides of the laminate is sealed so as to be lidded with a flat metal laminate sheet, whereby a battery can be produced.

Examples of the present invention are described below. It should be noted that the description here merely relates to illustrative examples of the present invention, and the present invention is not limited thereto.

### Example 1

A positive electrode active material (LiNi_{0.4}Mn_{0.3}CO_{0.3}O₂), acetylene black serving as a conductive agent, and CMC were mixed in a weight ratio of 90:5:5, to which pure water was added and mixed, to prepare a positive electrode slurry. The positive electrode slurry was applied onto a surface of a 15-μm-thick Al foil serving as a positive electrode current collector, and dried at 120° C. to remove water. The resultant product was rolled with a roll press, and cut into a predetermined size, and heated at 250° C. for 16 hours in a dry air (dew point temperature: 30° C.). A positive electrode plate was thus prepared.

A material including purified natural graphite having been surface-treated with pitch was used as a negative electrode active material. The negative electrode active material, CMC serving as a thickener, SBR serving as a binder were mixed in a weight ratio of 100:2:2, and mixed together while pure water was being added thereto, to prepare a negative electrode slurry. The negative electrode slurry was applied onto a surface of a 10-μm-thick copper foil serving as a negative electrode current collector, and dried at 200° C. to remove water. The resultant product was rolled with a roll press, and cut into a predetermined size. A negative electrode plate was thus prepared.

The positive and negative electrode plates prepared as above were wound with a separator (a 16-μm-thick polyethylene porous film, available from Asahi Kasei Corporation) interposed therebetween, to form a flat electrode group M1. A positive electrode lead or negative electrode lead was connected to each of the positive and negative electrode plates. In the electrode group M1, the width X was 19.6 mm, the thickness Y was 5.9 mm, and the length Z in the axis direction was 75 mm.

A battery case 2 made of Al in which the inside thickness L1 was 20 mm, the inside width L2 was 60 mm, and the inside height L3 was 80 mm was prepared. Ten electrode groups M1 arranged in a row were accommodated in the battery case such that the thickness directions of the electrode groups M1 were perpendicular to the thickness direction of the battery case. All the ten electrode groups M1 were connected in parallel with each other. The wall thickness of the battery case was 0.38 mm in both the wide and narrow side portions, and was 0.58 mm in the bottom portion.

The positive electrode leads extended from the electrode groups were connected in parallel with each other, and the negative electrode leads extended from the electrode groups were connected in parallel with each other. Each of the parallel-connected positive and negative leads was welded to the sealing plate 4 or the projection 3 via a current collecting lead.

Subsequently, a non-aqueous electrolyte prepared by dissolving LiPF₆ at a concentration of 1.0 mol/L in a mixed solvent of EC and EMC (volume ratio 3:7) was injected into the battery case 2. Thereafter, the sealing plate 4 was laser-welded to the opening of the battery case 2, to produce a battery of Example 1. Twenty batteries of Example 1 were produced in total.

### Example 2

The width of the battery case made of Al used as the battery case 2 was set to 70 mm. Two types of electrode groups were prepared: the first was the same as the electrode group M1 of Example 1, in which the width X was 19.6 mm, the thickness Y was 5.9 mm, and the length Z in the axis direction was 75 mm; and the second was an electrode group M2 in which the width X was 19.6 mm, the thickness Y was 4.8 mm, and the length Z in the axis direction was 75 mm. Ten electrode groups M1 of the first type and two electrode groups M2 of the second type were stacked and accommodated in the battery case such that the thickness directions of these electrode groups were perpendicular to the thickness direction of the battery case. Twenty batteries of Example 2 were produced in total in the same manner as in Example 1, except for the above.

### Example 3

The thickness and width of the battery case made of Al used as the battery case 2 was set to 32 mm and 70 mm, respectively. Four types of electrode groups were prepared: the first was the same as the electrode group M1 of Example 1, in which the width X was 19.6 mm, the thickness Y was 5.9 mm, and the length Z in the axis direction was 75 mm; the second was an electrode group M3 in which the width X was 11.6 mm, the thickness Y was 5.9 mm, and the length Z in the axis direction was 75 mm; the third was the same as the electrode group M2 of Example 1, in which the width X was 19.6 mm, the thickness Y was 4.8 mm, and the length Z in the axis direction was 75 mm; and the fourth was an electrode group M4, in which the width X was 11.6 mm, the thickness Y was 4.8 mm, and the length Z in the axis direction was 75 mm.

Ten electrode groups M1 of the first type and two electrode groups M2 of the third type were stacked in a row and accommodated in the battery case such that the thickness directions of these electrode groups were perpendicular to the thickness direction of the battery case. Ten electrode groups M3 of the second type and two electrode groups M4 of the fourth type were stacked in a row and accommodated in the same battery case such that the thickness directions of these electrode groups were perpendicular to the thickness direction of the battery case. Twenty batteries of Example 3 were produced in total in the same manner as in Example 1, except for the above.

### Comparative Example 1

A battery case made of Al having inside dimensions of 20 mm in thickness, 60 mm in width, and 80 mm in height was prepared. An electrode group M5 having a width of 59.6 mm, a thickness of 19.6 mm, and a length in the axis direction of 75 mm was produced in the same manner as in Example 1. The electrode group was accommodated in the battery case such that the thickness direction of the electrode group was parallel with the thickness direction of the battery case, the width direction of the electrode group was parallel with the width direction of the battery case, and the axis direction of the electrode group was parallel with the height direction of the battery case. Twenty batteries of Comparative Example 1 were produced in total in the same manner as in Example 1, except for the above.

### Comparative Example 2

A battery case made of Al having inside dimensions of 20 mm in thickness, 70 mm in width, and 80 mm in height was prepared. An electrode group M6 having a width of 69.6 mm, a thickness of 19.6 mm, and a length in the axis direction of 75 mm was produced in the same manner as in Example 1. Twenty batteries of Comparative Example 2 were produced in total in the same manner as in Comparative Example 1, except for the above.

### Comparative Example 3

A battery case made of Al having inside dimensions of 32 mm in thickness, 70 mm in width, and 80 mm in height was prepared. An electrode group M7 having a width of 69.6 mm, a thickness of 31.6 mm, and a length in the axis direction of 75 mm was produced in the same manner as in Example 1. Twenty batteries of Comparative Example 3 were produced in total in the same manner as in Comparative Example 1, except for the above.

The batteries of Examples 1 to 3 and Comparative Examples 1 to 3 were subjected to the following charge/discharge treatment, to evaluate the swelling and charge/discharge characteristics of each battery.

### (Charge/Discharge Treatment)

The batteries of Example 1 were placed in a 45° C. constant temperature bath and each charged at a charge rate of 0.8 C with a charge cut-off voltage set at 4.2 V, and then discharged at a discharge rate of 1 C with a discharge cut-off voltage set at 3.0 V. The above charge and discharge were taken as one cycle, and 300 charge/discharge cycles were performed, while the discharge capacity was measured every cycle.

The degree of deformation (the degree of swelling relative to the initial thickness) and the average capacity retention rate of the twenty batteries having been subjected to the above charge/discharge treatment were calculated. In the same manner as above, the degree of deformation and the average capacity retention rate of the twenty batteries of each of Examples 2 and 3 and Comparative Examples 1 to 3 were calculated.

The measurement for determining a degree of deformation of the battery was performed after allowing the initial batteries and the batteries having been subjected to charge/discharge treatment to stand for 2 hours in a 25° C. atmosphere. More specifically, the thickness of the battery was measured with a micrometer at the centers of the pair of wide side portions of each initial battery. Besides, the width of the battery was measured with a micrometer at the centers of the pair of narrow side portions of each initial battery. As for the batteries having been subjected to charge/discharge treatment, too, the thickness and width were measured in the same manner as for the initial batteries.

The capacity retention rate was determined by dividing the discharge capacity at the 300th cycle by the discharge capacity at the 1st cycle in the charge/discharge treatment of each battery, and averaging the obtained retention rates.

The results are shown in Table 1. In Table 1, with regard to the degree of deformation, a plus value means that the battery swelled, and a minus value means that the battery shrunk.

TABLE 1

| | | | | | | | | | Degree of | | |
|---|---|---|---|---|---|---|---|---|---|---|---|
| | Inside | | | | | | | | deformation | | |
| | dimensions | | | Outside | | | | | of battery | | |
| | of battery | | | dimensions | | | | | case | | Capacity |
| | case | | | of electrode | | | | Number of | (mm) | | retention |
| | (mm) | | | group (mm) | | | | electrode | Thickness | Width | rate |
| | L1 | L2 | L3 | | X | Y | Z | groups | direction | direction | (%) |
| Ex. 1 | 20 | 60 | 80 | M1 | 19.6 | 5.9 | 75 | 10 | 0.19 | 0.02 | 92.2 |
| Ex. 2 | 20 | 70 | 80 | M1 | 19.6 | 5.9 | 75 | 10 | 0.23 | 0.02 | 91.3 |
| | | | | M2 | 19.6 | 4.8 | 75 | 2 | | | |
| Ex. 3 | 32 | 70 | 80 | M1 | 19.6 | 5.9 | 75 | 10 | 0.25 | 0.02 | 90.3 |
| | | | | M3 | 11.6 | 5.9 | 75 | 10 | | | |
| | | | | M2 | 19.6 | 4.8 | 75 | 2 | | | |
| | | | | M4 | 11.6 | 4.8 | 75 | 2 | | | |
| Com. | 20 | 60 | 80 | M5 | 59.6 | 19.6 | 75 | 1 | 1.23 | −0.08 | 85.4 |
| Ex. 1 | | | | | | | | | | | |
| Com. | 20 | 70 | 80 | M6 | 69.6 | 19.6 | 75 | 1 | 1.48 | −0.09 | 81.6 |
| Ex. 2 | | | | | | | | | | | |
| Com. | 32 | 70 | 80 | M7 | 69.6 | 31.6 | 75 | 1 | 1.62 | −0.12 | 79.3 |
| Ex. 3 | | | | | | | | | | | |

In the batteries of Examples 1 to 3, the degree of deformation in the thickness direction of the battery case after charge/discharge treatment was about 0.2 mm, whereas in the batteries of Comparative Examples 1 to 3, the degree of deformation in the thickness direction of the battery case after charge/discharge treatment reached as high as 1.23 to 1.64 mm. The above comparison shows that, in the batteries of Examples 1 to 3, the swelling in the thickness direction was suppressed, although a prismatic battery has a tendency to swell in the thickness direction by repetitive charge and discharge.

The foregoing results are presumably attributable to the following: in the batteries of Examples 1 to 3, the width direction of the flat electrode group, in which direction the swelling due to repetitive charge and discharge is small, is directed to the wide side portions of the battery case where the pressure resistance is low, while the thickness direction of the flat electrode group, in which direction the swelling is large, is directed to the narrow side portions of the battery case where the pressure resistance is high, and therefore, the batteries of Examples 1 to 3 exhibited less swelling even though they were prismatic batteries. In contrast, the batteries of Comparative Examples 1 to 3 swelled significantly in the thickness direction of the battery.

In the batteries of Examples 1 to 3, the degree of deformation in the width direction of the battery case after charge/discharge treatment was as small as about 0.02 mm, that is, the thickness was not much changed from the initial thickness. In contrast, in the batteries of Comparative Examples 1 to 3, the swelling in the thickness direction of the battery case after charge/discharge treatment was great, and because of this, a shrinkage of 0.08 mm to 0.12 mm was observed in the width direction of the battery case. This would be easily understood from the following results: even among Comparative Examples 1 to 3, the higher the degree of deformation in the thickness direction of the battery case was, the higher the degree of deformation in the width direction of the battery case was.

As for the capacity retention rate, in the batteries of Examples 1 to 3, the capacity retention rates after charge/discharge treatment exceeded 90%. In contrast, in the batteries of Comparative Examples 1 to 3, the capacity retention rates were around 80%, showing that the batteries of Examples 1 to 3 are more excellent in cycle characteristics.

The foregoing results are presumably attributable to the following: in the batteries of Examples 1 to 3 in which the swelling was suppressed as described above, the cycle deterioration was also suppressed, resulting in little or no occurrence of buckling and the like, and therefore, the characteristic deterioration was small. It is noted, however, that both in Examples and in Comparative Examples, the characteristic deterioration tended to be severer as the shape of the battery case became larger in size. As described above, according to the present invention, it is possible to suppress the battery swelling due to charge/discharge cycles, and provide a non-aqueous electrolyte secondary battery having excellent cycle characteristics.

### INDUSTRIAL APPLICABILITY

The battery of the present invention is particularly useful as a lithium ion secondary battery including wound electrolyte groups in which the energy density is improved by increasing the densities of the positive electrode active material and negative electrode active material.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1, 14, 16 and 17 . . . Battery; 2 . . . Battery case; 5, 15, 18 and 19 . . . Electrode group; 6 . . . Positive electrode plate; 7 . . . Negative electrode plate; 8 . . . Separator

1. A non-aqueous electrolyte secondary battery comprising: a plurality of flat electrode groups, a non-aqueous electrolyte, and a prismatic case accommodating the electrode groups and the non-aqueous electrolyte,
the electrode groups each including a positive electrode, a negative electrode, and a separator, the positive electrode, the negative electrode, and the separator being wound into a flat shape,
the case has a rectangular cross-sectional shape, and
the electrode groups being accommodated in the case such that lateral directions of cross-sectional shapes of the electrode groups are each perpendicular to a lateral direction of the cross-sectional shape of the case, and axis directions of the electrode groups are each parallel with a height direction of the case, and
at least one of the electrode groups being different from another one of the electrode groups in terms of the length in the lateral direction of the cross-sectional shape.

2. The non-aqueous electrolyte secondary battery according to claim 1, wherein at least two of the electrode groups are connected in parallel with each other.

3. The non-aqueous electrolyte secondary battery according to claim 1, wherein at least two of the electrode groups are connected in series with each other.

4. The non-aqueous electrolyte secondary battery according to claim 1, wherein the electrode groups include three or more electrode groups, and include at least two electrode groups connected in parallel with each other and at least two electrode groups connected in series with each other.

5. The non-aqueous electrolyte secondary battery according to claim 1, wherein in at least two of the electrode groups, the positive electrode, the negative electrode, and the separator are each continuous in one.

6. The non-aqueous electrolyte secondary battery according to claim 1, wherein a ratio of a length in a longitudinal direction to a length in the lateral direction of the cross-sectional shape of at least one of the electrode groups is smaller than a ratio of a length in a longitudinal direction to a length in the lateral direction of the cross-sectional shape of the case.

7. (canceled)

8. The non-aqueous electrolyte secondary battery according to claim 1, wherein the electrode groups include two or more row elements, the row elements each comprising two or more electrode groups arranged in a row in the longitudinal direction of the cross-sectional shape of the case, and the two or more row elements are arranged side by side in the lateral direction of the cross-sectional shape of the case.

9. (canceled)

10. A non-aqueous electrolyte secondary battery comprising: a plurality of flat electrode groups, a non-aqueous electrolyte, and a prismatic case accommodating the electrode groups and the non-aqueous electrolyte,
the electrode groups each including a positive electrode, a negative electrode, and a separator, the positive electrode, the negative electrode, and the separator being wound into a flat shape,
the case having a rectangular cross-sectional shape,
the electrode groups being accommodated in the case such that lateral directions of cross-sectional shapes of the electrode groups are each perpendicular to a lateral direction of the cross-sectional shape of the case, and axis directions of the electrode groups are each parallel with a height direction of the case, and
the electrode groups including two or more row elements, the row elements each comprising two or more electrode groups arranged in a row in a longitudinal direction of the cross-sectional shape of the case, and the two or more row elements being arranged side by side in the lateral direction of the cross-sectional shape of the case.

11. The non-aqueous electrolyte secondary battery according to claim 10, wherein at least two of the electrode groups are connected in parallel with each other.

12. The non-aqueous electrolyte secondary battery according to claim 10, wherein at least two of the electrode groups are connected in series with each other.

13. The non-aqueous electrolyte secondary battery according to claim 10, wherein the electrode groups include three or more electrode groups, and include at least two electrode groups connected in parallel with each other and at least two electrode groups connected in series with each other.

14. The non-aqueous electrolyte secondary battery according to claim 10, wherein in at least two of the electrode groups, the positive electrode, the negative electrode, and the separator are each continuous in one.

15. The non-aqueous electrolyte secondary battery according to claim 10, wherein a ratio of a length in a longitudinal direction to a length in the lateral direction of the cross-sectional shape of at least one of the electrode groups is smaller than a ratio of a length in the longitudinal direction to a length in the lateral direction of the cross-sectional shape of the case.

16. The non-aqueous electrolyte secondary battery according to claim 10, wherein the lengths in the longitudinal directions of the cross-sectional shapes of the electrode groups constituting at least two row elements adjacent to each other in the lateral direction of the cross-sectional shape of the case are different from one another.
